(19) United States
(12) Patent Application Publication
(10) Pub. No.: US 2009/0050809 A1
(43) Pub. Date: Feb. 26, 2009

(54) Fluid Flow Monitoring Device

(76) Inventor: Henry Victor Holec, Mendota Heights, MN (US)

Correspondence Address: PYLE & PIONTEK LLC, 221 N. LASALLE STREET, SUITE 2036, CHICAGO, IL, 60601, US

(21) Appl. No.: 10/592,578

(22) PCT Filed: Mar. 11, 2005
(86) PCT No.: PCT/GB05/01126

§ 371 Date: Jul. 10, 2007

(30) Foreign Application Priority Data
Mar. 12, 2004 (GB) 0405596.8

(51) Int. Cl. G01J 5/02

(52) U.S. Cl. 250/343

(57) ABSTRACT

A device for use in monitoring optical markers present in a liquid flowing in a conduit comprises a transparent tube 7 connectable in the conduit by pipe couplers (not shown) contained in housings 8, 9, and two optical tranceivers 1, 2 mounted on a segmented printed circuit board 3, 4 wrapped around the tube 7 such that the tranceivers 1, 2 face one another. In use, the tranceivers 1,2 produce infra-red radiation and detect infra-red radiation transmitted and/or reflected by any optical markers, e.g. bubbles, present in the liquid. The tranceivers 1, 2 are connected to a digital signal processor (not shown) programmed to determine, from the signals, a selected property, e.g. carbonation level, of the liquid.

This invention relates to devices for monitoring fluid flow in a conduit and more particularly to devices adapted to detect “optical markers” (as hereinbefore defined) such as gas bubbles, foam, pulp or other suspended solids present in the fluid, and to process signals, as desired, generated in response to detection of the optical markers. The devices have a wide range of applications, for example in beverage dispensing systems.

There are currently a number of fluid flow monitoring devices on the market that can either measure flow rates or detect liquid to gas transitions (bubbles) in a fluid conduit—but not both. They use a number of different technologies—most of which either interrupt, deflect, or impede the normal flow inside a conduit, such as a tube. A few types, including ultrasonic and Doppler types, are not invasive, but generally rely on homogeneous, constant density fluids to perform accurately. These systems are adversely affected by bubbles and other optical markers randomly mixed in the fluids they are measuring. The market lacks a fully non-invasive device that can accurately measure flow rates and other physical quantities of the fluid.

Liquid phase and bubble detectors can be found in the market for detection of gas entrained in liquid flow, or liquid and solids entrained in gas flow (phase transitions). Some of these detectors use optical means for detecting phase transitions by shining a light beam through a tube and detecting its passage or reflection with a photo-detector. These detectors work by measuring reflected or transmitted light, but not both. Therefore, a detector working with transmitted light does not simultaneously detect reflected light. A fluid consisting of a high density of light refracting and reflecting particles (eg ice slurry) cannot readily be seen to have phase transitions unless the light passes entirely through. Likewise, a reflected light detector does not readily work with highly transparent fluids, unless bubbles or other optical markers in the flow have very specific geometries or structures that reflect light. Further, fluid flows that transition rapidly between primarily transmissive and reflective states (e.g. ice slurry passing through a tube that recently contained a purely liquid carbonated beverage) present special problems for detectors arranged to detect only one or the other.

It is the object of the present invention to provide a multipurpose device for monitoring fluid flow in a conduit, and a signal processing system capable of detecting and measuring, either simultaneously or selectively, several physical properties of the fluid flowing in the conduit. The physical properties that can be detected and measured with this device include:
Presence detection and frequency measurement of optical markers flowing through a fluid conduit.
Measurement of velocity (and therefore flow rate) of fluid flowing through the conduit.
Determination of the sizes and general shapes of optical markers flowing through the conduit.
Measurement of the transmissivity and reflectivity of fluid passing through the conduit, including rate of change.
Detection and tracking fluid phase or fluid type transitions as they pass through the conduit.

The occurrence, the frequency, the size(s), and the velocity of a variety of optical markers that are present in fluid flow (including bubbles, pulp, foam, phase transitions in gas and liquid, and fluid transitions from one fluid type to another) are extremely useful in a variety of fluid monitoring and feedback applications. The device is designed to work with a wide variety of fluids, particularly pre- and post-mix beverages (hot, cold, or frozen), and in a variety of other gas flow and liquid flow applications.

By the term “optical marker” used herein, we mean any element in the flowing fluid that causes reflection, refraction or blocking of light from a light source incident on the fluid, including but not limited to small solid or semi-solid particles, droplets, fluid droplets occluded within another fluid, bubbles and fluid filaments. Usually, as the optical marker passes the incident light source, it creates a pulse like signal of finite duration which can be sensed by a light sensor forming part of the device. The optical markers may vary in size and position in the fluid flow (and therefore produce at the sensor signals of different pulse strengths and duration), but generally the signals for a given type of optical marker are consistently repeatable in form, making them readily identifiable.

According to one aspect of the present invention, there is provided a device for monitoring fluid flowing in a conduit, for example a pipe or tube, having a transparent or translucent section, the device comprising light generating means for generating light and directing it towards the flowing fluid through the transparent or translucent section and light sensing means for selectively sensing light reflected and transmitted by the flowing fluid.

According to another aspect of the present invention, there is provided a device for monitoring fluid flowing in a conduit, the device including a pair of optical transceivers each acting as both an emitter and detector of light and located on opposite sides of a transparent or translucent section of the conduit.

The devices of the invention defined above therefore constitute devices that have “universal” applicability in that they allow the detection of, selectively, depending on the application, opaque, refractive and/or reflective optical anomalies (ie optical markers) that naturally occur or are induced in the fluid flowing between through the conduit. These markers either block or scatter light transmission through the fluid, or reflect it directly back, in such a way to enable detection of the presence and movement of the optical markers.

A device of the invention is preferably either embodied in a “crocodile clip” that may be securely clipped onto the transparent or translucent section of the conduit or is permanently mounted on a transparent or translucent section of the conduit.

As markers flow down the conduit, light detected at the light sensing means, eg each transceiver, is converted to a proportional current. The light sensing means may comprise, eg, a phototransistor, although other means such as photodiodes, charge coupled devices or photomultipliers may be used. The current produces a voltage when passed through a load resistor. Voltage signals from the light sensing means are processed to extract information about the fluid passing between them. The light sensing means is receiving a mixture of transmitted and reflected signal from which information is extracted. It is this “transflective” mode of operation that gives a device of the invention such a wide range of detection and measurement capability.

The light may be visible or invisible electromagnetic radiation and for many applications is preferably infra-red radiation. Further, for example in a particular device, the light generating means may emit visible white light or multiple colours of light and the light sensing means may be adapted to sense one or more individual colours. Thereagain the light generating means may emit one frequency of light and the sensing means may be adapted to sense light derived therefrom in the fluid, e.g. fluorescence or phosphorescence.

Rather than using, say, a pair of optical transceivers, an alternative arrangement in which a reflector or optical refraction element is positioned on one side of the conduit (opposite the transceivers) can be used to produce similar transflective measurement signals. In this case, transmitted light is doubled back through the conduit after striking the reflector. Reflective light bounces off optical markers in the fluid and is returned directly to one or both transceivers. In this arrangement it is desirable to symmetrically arrange the emitter light sources so that both detectors may receive light reflected by or transmitted through the fluid with balanced (but separate) optical paths.

In yet another, simplified, arrangement, a reflector or optical refraction element is placed on one side of the conduit opposite a single transceiver. This configuration works in the same manner as the previous arrangement, but lacks the ability to directly measure velocity (flow rate). However, this arrangement can be used to directly measure four of the five physical quantities listed above.

Various physical quantity measurements are derived from the transceiver arrangements by applying appropriate signal processing techniques.

Detection of the presence and the frequency of optical markers flowing through a fluid conduit is performed by analyzing the transceiver signals for either the positive and negative pulse transitions that arise as markers move past the transceivers (as opposed to the steady state voltage output when no markers are present).

Measurement of velocity (and therefore flow rate) of optical markers flowing through the conduit is conducted by detecting a marker or transition flowing past one detector and measuring the time delay until the same optical marker is detected at the second detector. The time delay is inversely proportional to velocity.

Determination of the sizes of optical markers flowing through the conduit requires prior knowledge (or direct measurement) of the current velocity. Optical markers produce pulse signatures at the detectors that are in time length proportional to both their size and their velocity in the conduit. By dividing out the velocity, the size can be accurately estimated.

Measurement of the transmissivity and reflectivity of fluid passing through the conduit (or the combined transflectivity) can be determined by individually or alternately turning off the light sources of the paired transceivers. The transmissivity is determined by measurement of the signal coming from the detector opposite the active light source. The reflectivity is determined from the signal coming from the detector on the same side as the active light source. Rate of change of transmissivity and reflectivity is conducted by repeating these measurements and dividing by the time that has passed between measurements.

Detection of fluid phase or fluid type transitions as they pass through the conduit are similar to other optical markers, except that fluid transitions are generally marked by a step in transmissivity, reflectivity and/or transflectivity rather than the pulses produced by other types of markers. Also, in the case of gradual transitions, such as those occurring between miscible fluids, the rate of change of reflectivity, transmissivity, and/or transflectivity may be relatively slow.

A device of the invention may therefore be used to detect and measure multiple physical quantities, useful in a number of fluid flow control, quality monitoring, and feedback applications. Examples of applications in beverage dispense (although it will be appreciated that the invention has a wide range of other applications) include the following:
Carbonation level measurement—by observing bubble formation and collapse.
FOB detection—foam and out of product detection by observing bubble frequency.
Closed loop FOB control—using the bubble frequency to control or close off flow.
Freeze up detection—detection of ice crystals forming in the conduit.
Binary ice crystal formation and ice slurry flow control—measuring crystal sizes, frequency and flow rate.
Frozen beverage or frozen carbonated beverage (FCB) product uniformity and flow rate measurement
Ice bank control—slush detection via ice crystal frequency and size measurement.
Refrigeration control—monitor phase transitions in the evaporator or condensing coils.
Back slugging detection—by monitoring fluid transition, liquid to gas.
Detect pirate products—carbonated beverages, syrups, and additives by virtue of their light transmission or reflectivity.
Beer flow metering—measure flow rate.
Out of syrup detection—detection of foaming or phase transitions.
Detecting dirt in line—detection of particles
Beer line cleaning sequence control—measure, track and control fluid-to-fluid transitions in the line.
Cleaning fluid detection—detect cleaning fluid by its transflectivity.
Throughput monitor—flow measurement integrated over time
Syrup flow metering—measure syrup flow rate and control valves or pumps to maintain targeted flow.
Flow measurement of juices and concentrates—flow measurement by detection of pulp.
Ratio control for juice dispense—measurement of pre- and post-mix pulp frequency, flow rate, or transmissivity, adjusting the ratio toward target.
Intermediate carbonation level detection and control—measure frequency and size of bubbles.
Monitor inline carbonation—measure frequency and size of bubbles.
Difference between N² and CO² based on bubble size.
Organic/effluent build-up in line—plaque thickness by transflectivity measurement and particulate detection.
Bar guns—pre mix ration control and metering in back rooms.
Beer head control—measure bubble formation and control.
Measure foaming and bubbles and control flow to minimize breakout while maximizing flow rate.
Coolant recirculation phase monitoring—measure phase transition in the coolant.
Water Quality tester—effluents and particles detected in water flow.

The invention will now be described in more detail, by way of example only, with reference to the accompanying drawings in which:

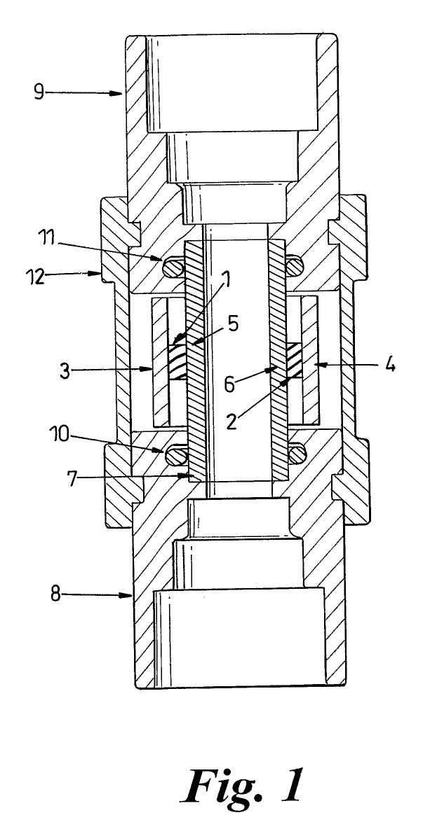

FIG. 1 is a longitudinal cross-section of one form of device of the invention;

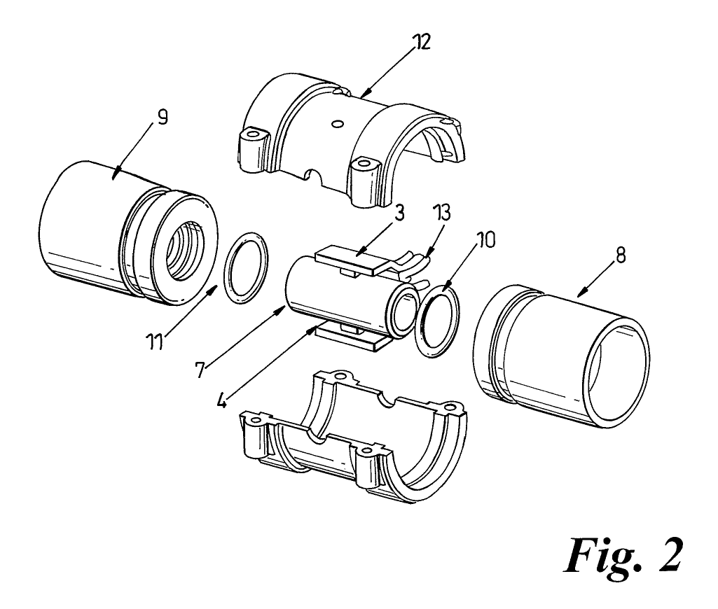

FIG. 2 is an exploded perspective view of the device shown in FIG. 1;

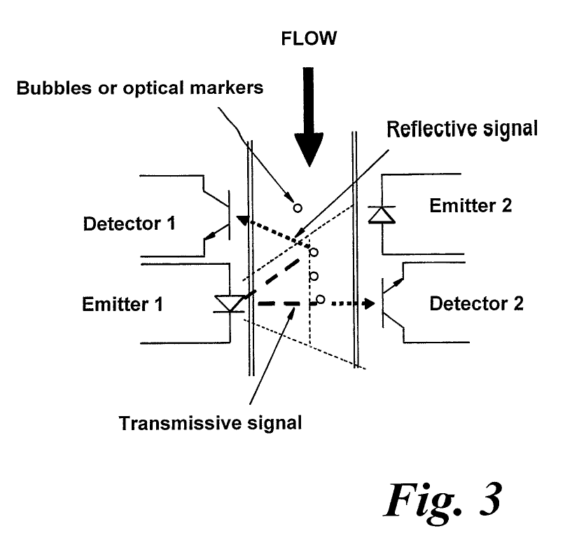

FIG. 3 is a schematic diagram illustrating the light-generating and sensing functions of the device shown in FIGS. 1 and 2;

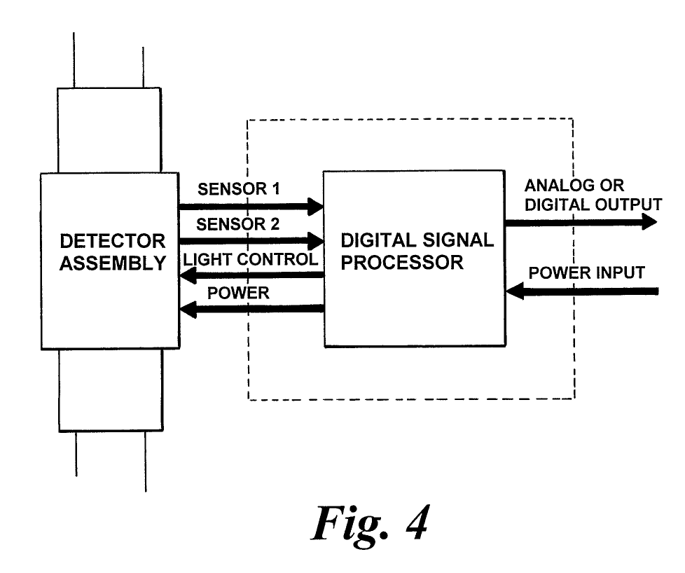

FIG. 4 is a schematic diagram showing the interface between a device of the invention and a digital signal processing unit;

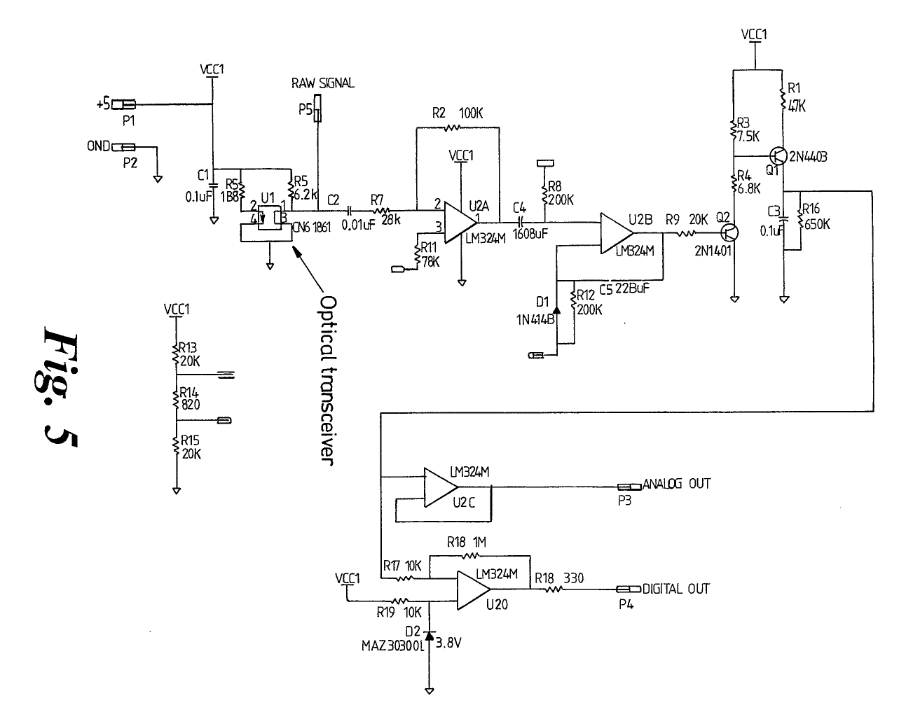

FIG. 5 is a schematic circuit diagram of a signal processing unit for use with a device of the invention;

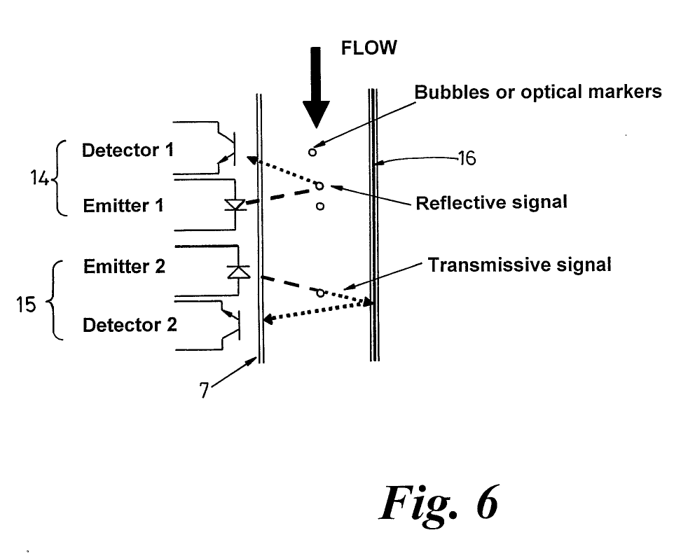

FIG. 6 is similar to FIG. 3 but in relation to an alternative device of the invention;

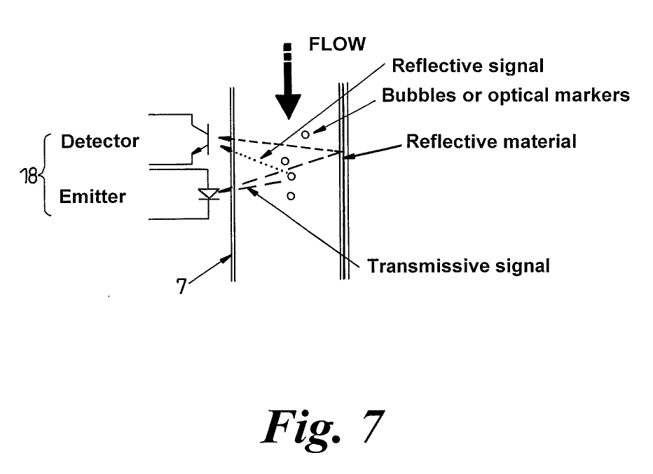

FIG. 7 is similar to FIG. 3 but in relation to yet another alternative device of the invention; and

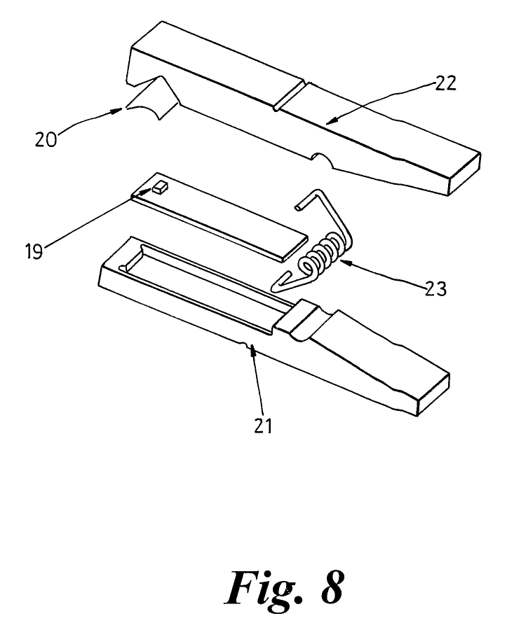

FIG. 8 is an exploded perspective view of a device of the invention incorporated in a “crocodile clip”.

Referring to FIGS. 1 and 2, two optical transceivers 1, 2 (Panasonic CNB2001 Photo sensor or equivalent) are positioned on a segmented printed circuit board 3, 4, such that the infrared light sources from each will eventually be aimed into the detectors of the other. Two shallow flats 5, 6 are cut into opposite sides of a transparent Acrylic tube 7 (or similar transparent or semi transparent tube). The board is wrapped around the tube and the optical transceivers affixed to the tube at the flats by optical cement. Plastic coupler housings 8, 9 (made of Delrin or similar plastic) are installed at either end of the tube, sealed to the tube by o-rings 10,11. A plastic clam shell housing 12 (made of Delrin or similar plastic) covers the tube and locks the couplers in place. The coupler housings accepts press-in fittings (for example Norgren 12-008-0600 fittings), which allow the assembly to be used with standard flexible tubing.

Electrical leads 13 extend from the printed circuit board for connection to either a Digital Signal Processing Board (FIG. 4), or to an Optical Marker and Frequency Detection Circuit (FIG. 5). Alternative embodiments, including integration of either of these circuits and the printed circuit board carrying the optical transceivers, are possible. In one embodiment, the leads 13 were connected to data capture card (Measurement Computing Corporation Model PC-Card-DAS16/12A0) installed in a laptop personal computer (Dell Model PP01X). Software algorithms developed on the personal computer were used to implement the five physical quantity measurements made possible by this invention. However, software algorithms could have been implemented for any type of computer, microprocessor, or signal processing chip, including the integrated signal processor shown in FIG. 5.

FIG. 3 illustrates how the transceivers of the device shown in FIGS. 1 and 2 produce and detect infrared light transmitted and/or reflected by bubbles or other optical markers.

In a second embodiment, side-by-side optical transceivers 14, 15 are positioned on a printed circuit board in the emitter/detector order illustrated in FIG. 6. Two optical flats are cut into opposite sides of a transparent Acrylic tube 7, spanning the two optical transceivers. The optical transceivers are affixed to the tube by optical cement, aligned to the centre line of one of the flats. On the opposite flat, a thin sheet of reflective foil 16 (in this case aluminium foil, although a variety of different types of reflective sheets or coatings are possible) is affixed with optical cement. In this embodiment the tube, plastic coupler housings, clam shell housings, o-ring seals and press-in fittings are assembled as described above.

Referring to FIG. 7 another embodiment is shown in which the side-by-side optical transceivers are replaced by a single transceiver 18 affixed to the Acrylic tube 7 as described above. A reflective sheet is also mounted as described above. Likewise, the tube, plastic coupler housings, clam shell housings, o-ring seals and press-in fittings are assembled as described above.

In yet another embodiment, the single transceiver arrangement described above is modified by having the complete Optical Marker and Frequency Detection Circuit (shown in FIG. 5) on the same circuit board as the transceiver. The transceiver is mounted to the tube as before. The clam-shell housing is made slightly larger to accommodate the circuit, but essentially the tube and housing assembly were unchanged.

Referring to FIG. 8 an embodiment is shown using the combined single transceiver (FIG. 7) and Optical Marker and Frequency Detection Circuit board (FIG. 5) implemented in a clamp for arrangement with existing transparent and semi-transparent tubing. In this design, the transceiver 19 and the opposing reflector sheet 20 are mounted into a spring loaded clamp comprising two clamp arms 21, 22 and a spring 23, such that closing the clamp on a tube results in the transceiver being brought into contact at one side of the tube and the reflector sheet on the other.

Algorithms used in the preferred embodiment (implemented on a personal computer) for each of the five types of physical measurement are described below:

### Frequency of Markers:

The frequency of passing markers is obtained by analyzing the signal sourced at one of the photo detectors. Software digital signal processing algorithms were used in the preferred embodiment, although analogue processing could have been used for the same result. In this embodiment, the voltage signal from the sensor is sampled at a sufficiently high frequency (in this case 100 KHz) to assure pulse detection for optical markers (in this case bubbles, ice crystals, and juice pulp were tested as markers). A low pass digital filter was applied to the signal samples to reduce high frequency noise. Individual pulses were detected by examining the sampled data for rapid voltage level changes (slope greater than a predetermined threshold). Each detected pulse was counted as a single pulse event. Detection of a reversed change (negative slope) resets the algorithm to look for the next pulse event. The frequency of markers was simply calculated as the number of pulse events per unit time.

### Flow Velocity and Flow Rate:

Flow velocity is calculated by measuring the time of flight of a marker moving from the upstream detector to the downstream detector. In the preferred embodiment, two signals, each sampled and captured at 100 KHz, are processed. The signal coming from the upstream photo detector is examined for rapid voltage level changes (slope greater than a predetermined threshold). When such a change is detected the signals for both the upstream and downstream sensors are frozen into buffers. The buffered data includes samples starting just prior to the triggering event and ending well after the event (in this case 500 samples were used from each detector, 125 before trigger and 375 after). The amount of data buffered (and subsequently processed) is chosen to be to be slightly slight larger than the maximum expected propagation delay between the detectors plus the time length of a marker at the slowest flow rate.

Data in the downstream signal buffer is examined for a rapid voltage change similar to the change detected in the upstream buffer. This test is not necessary, but in the preferred embodiment is shown to reduce the number of false correlations occurring from noise or detection of a marker that is not in the downstream detector field of view.

After passing the previous test, signals from both buffers are run through a cross-correlation algorithm. The result is tested for a correlation peak in the range of minimum expected propagation delay (generally zero) to maximum expected propagation delay (determined by the maximum expected flow velocity through the sensor). This centre of this peak indicates the likely propagation delay of a marker between the upstream and downstream detectors. The correlation value at this peak indicates the quality of the correlation (a normalize value in the range of −1.0 to +1.0). In the preferred embodiment, the measurement is deemed acceptable if the correlation values of greater than a minimal threshold (typically greater than +0.5).

Individual propagation delays measured in this way are combined into rolling averages to minimize the variance. Because marker elements ride inside of the fluid flow, and because the flow velocity within the conduit varies across the conduit (slowest at near the walls and fastest at the centre), it is necessary to average several individual measurements to gain an accurate average flow velocity. The average flow velocity, multiplied by the conduit cross sectional area, predicts the flow rate.

However, in practice, it is difficult to measure the exact cross sectional area and there are a number of error factors, such as changes in flow distribution as a function of flow rate, fluid viscosity, and texture and geometry of the conduit. In the preferred embodiment, a stored calibration curve obtained from direct measurement, that corrects the effective conduit cross sectional area as a function of measured average flow velocity is used for highest accuracy.

In the preferred embodiment, a method of detecting and suppressing errant individual propagation measurements is employed that uses prior measurement history. Recent measurements (including any measurements that were judged to be out of bounds for inclusion into the rolling average) are used to calculate a variance or standard deviation value. The newest measurement is accepted into the rolling average if it is within a predetermined number of standard deviations from the recent average. Typically the accepted range has been plus or minus one standard deviation.

### Marker Size Measurement:

Marker size is determined by knowing the velocity of a marker (either by the direct measurement discussed above or by another measurement means) and multiplying the velocity by the time length of the marker as it is detected on one or both detectors. In the preferred embodiment, the time length of the marker is taken as the time difference between the detection of a rapid voltage change at one detector, and the subsequent detection of the negative of this voltage change on the same detector. A variety of other methods may be employed to determine the marker time length, including pulse width above or below a fixed or floating threshold, done separately or combined with digital filtering and de-convolution of a detected pulse with a modelled zero time length impulse response pulse (the zero time length impulse response pulse models the optical resolution of detector and the edge effects and scatter from the marker, along with any electrical low pass or distortion effects that might be present in the detector and its amplification circuit).

### Transflectivity Measurement:

Transmitted and reflected light are superimposed and received by each detector. In the preferred embodiment, a useful measurement of the efficiency of combined light transfer (transflectivity) is made by adjusting the light output of each sensor alternately and in combination. In the software algorithm running on a personal computer, current supplied to each emitter is controlled by the software program (implemented as voltage provided to a pull-up resistor supplying the photo LED). The current flowing through each detector (measured as a voltage across a load resistor) is measured. The algorithm starts by bringing up the current in one of the two emitters (Emitter 1) (the other held to zero) until the current in either one of the detectors reaches a predetermined mid-scale value (plus or minus a small tolerance). The current on Emitter 2 is raised to the same level causing both detector currents to rise above the mid-scale value. Emitter 1 current is then dropped until one of the detectors reaches mid-scale again. The current on the Emitter 2 is now reduced incrementally. Each time a detector drops below the mid-scale value, Emitter 1 current is increased until both detectors are at or above mid-scale again. This process is repeated until both detectors are at mid-scale (plus or minus a small tolerance). At this point the current settings of Emitter 1 and Emitter 2 are averaged. The average current value measured in this way is divided into the average current measured by this algorithm when the conduit is clean and filler with dry air. The resulting ratio is used as a measurement of the combined light transfer efficiency (transflectivity). Several algorithms are possible using the same sensor, producing similar measurements or either light transmissivity, light reflectivity, or the combined measurement of transflectivity.

### Fluid Transition Detection:

Fluid transitions and phase changes are measured by examining the detector signals for non-return-to-zero (low frequency) changes. Transitions between fluids are detected as changes in transflectivity as one fluid is replaced under a detector by a second. Correlation of the transflectivity signal from one detector with pre-programmed (modelled or measured) signature of a fluid transition, allows precise detection and location of the transition.

1-16. (canceled)

17. A device for use in monitoring optical markers present in a fluid flowing in a conduit, the device comprising light-emitting means for generating light and directing it through the fluid in a generally transverse direction to its direction of flow, and light-sensing means for selectively sensing light reflected and transmitted as the fluid flows through the conduit.

18. A device according to claim 17, further comprising one of a transparent or translucent tubular member for connection into the conduit, the light-emitting and light-sensing means being mounted on the tubular member.

19. A device according to claim 17, wherein the light-emitting and light-sensing means are mounted on clip means adapted to be securely and removably clipped onto a transparent or translucent section of the conduit.

20. A device according to claim 17, wherein the light-emitting means and the light-sensing means are comprised of a pair of optical transceivers each acting as both an emitter and sensor of light and located substantially opposite one another.

21. A device according to claims 17, wherein the light-emitting means and the light-sensing means are comprised of at least one optical transceiver and wherein at least one of a light-reflective or refractive material is mounted substantially opposite said transceiver for reflecting back any light transmitted through the flowing liquid.

22. A device according to claim 21 wherein said at least one optical transceiver comprises a pair of optical transceivers in spaced, side-by-side relationship.

23. A device according to claim 17, wherein the light-emitting means and the light-sensing means are respectively adapted to emit and sense infra-red radiation.

24. A device according to claim 17, including signal processing means for selectively processing signals generated, in use, by the light-sensing means in response to its sensing light incident thereon.

25. A device according to claim 24, wherein the signal processing means is embodied in a printed circuit board on which at least one of the light-emitting means and the light-generating means is mounted.

26. A device according to claim 17, including means responsive to said light-sensing means for detecting the presence and frequency of optical markers in the fluid.

27. A device according to claim 17, including means responsive to said light-sensing means for measuring at least one of the velocity and flow rate of the fluid.

28. A device according to claim 17, including means responsive to said light-sensing means for determining at least one of the sizes and general shapes of optical markers present in the fluid.

29. A device according to claim 17, including means responsive to said light-sensing means for measuring at least one of the transmissivity and reflectivity of the fluid.

30. A device according to claim 17, including means responsive to said light-sensing means for detecting fluid phase transitions in the fluid.

31. A device according to claim 17, including means responsive to said light-sensing means for tracking fluid phase transitions in the fluid.

32. A device according to claim 17, including a beverage dispenser, and means for mounting said device in and coupling said device to said beverage dispenser for monitoring and/or controlling operation of said beverage dispenser.

33. A method of monitoring optical markers present in a fluid flowing in a conduit, said method comprising the steps of: emitting light; directing the emitted light through the fluid in a direction generally transverse to the direction of flow of the fluid; and selectively sensing light transmitted through and reflected by the fluid flowing through the conduit.

34. A method according to claim 33, further comprising the step of providing one of a transparent or translucent tubular member in-line with the conduit, said directing step directing the emitted light through the tubular member.

35. A method according to claim 33, including the step of providing one of a light reflective or refractive material to reflect light transmitted through the flowing fluid, said sensing step sensing light reflected by one of the light reflective or refractive materials.

36. A method according to cam 33, wherein said emitting step emits, and said sensing step senses, infra-red radiation.

38. A method according to claim 33, including the steps of generating signals in accordance with transmitted and reflected light sensed by said sensing step, and selectively processing the signals.

39. A method according to claim 38, wherein said selectively processing step is performed in a manner to provide an indication of at least one of the presence and frequency of optical markers in the fluid.

40. A method according to claim 38, wherein said selectively processing step is performed in a manner to provide an indication of at least one of the velocity and flow rate of the fluid.

41. A method according to claim 38, wherein said selectively processing step is performed in a manner to provide an indication of at least one of the sizes and general shapes of any optical markers present in the fluid.

42. A method according to claim 38, wherein said selectively processing step is performed in a manner to provide an indication of at least one of the transmissivity and reflectivity of the fluid.

43. A method according to claim 38, wherein said selectively processing step is performed in a manner to provide an indication of phase transitions in the fluid.

44. A method according to claim 38, wherein said selectively processing step is performed in a manner to track fluid phase transitions in the fluid.

45. A method according to claim 33, wherein said method is for monitoring optical markers present in a beverage flowing through a conduit of a beverage dispenser, and including the step of operating the beverage dispenser to dispense a beverage by flowing the beverage through the conduit, said directing step being performed to direct the emitted light through the beverage flowing through the conduit, and said sensing step being performed to sense light transmitted through and reflected by the beverage flowing through the conduit.
